(19) United States
(12) Patent Application Publication
(10) Pub. No.: US 2002/0188520 A1
(43) Pub. Date: Dec. 12, 2002

(54) Supplier provided product information service

(75) Inventors: Barry Edward Willner, Briarcliff Manor, NY (US); Edith Helen Stern, Yorktown Heights, NY (US); Philip Shi-Lung Yu, Chappagua, NY (US); David Perry Greens, Ossining, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/877,285

(22) Filed: Jun. 8, 2001

(51) Int. Cl. G06F 17/60

(52) U.S. Cl. 705/26

(57) ABSTRACT

A system, method, and computer program product for providing a post-sale customer service facility is disclosed. The present invention provides a commercial web site in which an inventory of products sold to a customer is maintained. The customer can use the inventory to look up information from the seller or manufacturer regarding the product or can engage in interactive information exchange with the seller's web site concerning the product.

### BACKGROUND OF THE INVENTION

1. Technical Field

The present invention is directed generally toward a method, system, and computer program product for conducting sales over a computer network. More specifically, the present invention is directed toward a web site for conducting on-line sales and providing post-sale information and assistance for customers' specific inventory of products as an additional service.

2. Description of Related Art

Internet, also referred to as an “internetwork” in communications, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Operating costs may be reduced by providing informational guides and/or searchable databases of public records online.

Currently, the most commonly employed method of transferring data over the Internet is to employ the World Wide Web environment, also called simply “the web.” Other Internet resources exist for transferring information, such as File Transfer Protocol (FTP) and Gopher, but have not achieved the popularity of the web. In the web environment, servers and clients effect data transaction using the Hypertext Transfer Protocol (HTTP), a known protocol for handling the transfer of various data files (e.g., text, still graphic images, audio, motion video, etc.). Information is formatted for presentation to a user by a standard page description language, the Hypertext Markup Language (HTML). In addition to basic presentation formatting, HTML allows developers to specify “links” to other web resources identified by a Uniform Resource Locator (URL). A URL is a special syntax identifier defining a communications path to specific information. Each logical block of information accessible to a client, called a “page” or a “web page,” is identified by a URL. The LRL provides a universal, consistent method for finding and accessing this information by the web “browser.” A browser is a program capable of submitting a request for information identified by a URL at the client machine. Retrieval of information on the web is generally accomplished with an HTML-compatible browser, such as, for example, Netscape Communicator, which is available from Netscape Communications Corporation.

When a user desires to retrieve a document, such as a web page, a request is submitted to a server connected to a client computer at which the user is located and may be handled by a series of servers to effect retrieval of the requested information. The selection of a document is typically performed by the user selecting a hypertext link. The hypertext link is typically displayed by the browser on a client as a highlighted word or phrase within the document being viewed with the browser. The browser then issues a hypertext transfer protocol (HTTP) request for the requested documents to the server identified by the requested document's URL. The server then returns the requested document to the client browser using the HTTP. The information in the document is provided to the client formatted according to HTML. Typically, browsers on personal computers (PCs) along with workstations are typically used to access the Internet. The standard HTML syntax of Web pages and the standard communication protocol (HTTP) supported by the World Wide Web guarantee that any browser can communicate with any web server.

Often applications or programs may be sent to a computer from a web server across the Internet. Java applications are becoming increasingly more prevalent as the type of application sent between web servers and client computers. The Java programming language and Java applets provides platform-independent application programs over the Internet and the World Wide Web. Programs written in the Java language can be executed on any computer platform having a Java interpreter. In addition, the integrity of programs written in Java may be verified prior to their execution. Java applications are common on the Internet and becoming more increasingly common in intranets and in other types of networks used in businesses.

From a business perspective, the expansion of the Internet has led to greater access of consumers to information, particularly comparative pricing information. The traditional “in-person” market is to a large extent an inefficient market—that is, “in-person” merchants can rely on consumers lacking most market pricing and valuation information, because in the “physical world,” researching competitive prices requires more effort, particularly when competitively shopping over a large geographic area. This makes it possible for vendors to compete without necessarily having the best available prices.

The Internet, however, makes an entire world of commercial information easily accessible to anyone with the right equipment. Shoppers can often easily find the lowest available price on-line, because shoppers can move from site to site easily and also because on-line pricing guides and price search engines eliminate much of the work, at least for some products. Thus, the on-line marketplace is to some extent a more efficient market. It behooves online merchants, therefore, to offer other consumer incentives than simply price. If every merchant offers the same product at the same price, other factors will have a much greater role to play in consumer choices.

One area in which there is much room for competition in the on-line marketplace is in customer service. There are several reasons why this is so. Good customer service greatly enhances a consumer's buying experience, sometimes more so than a low price; a happy customer will be a repeat customer, and may be less inclined to be particular about price if the customer receives good service. Another is that the “on-line” aspect of on-line commerce tends to put a barrier between the human parties to a transaction. Sometimes consumers need assistance, and offering that assistance is often a challenge when it must be presented by computer.

Thus, there exists a need for enhanced customer service facilities within an on-line shopping context. The present invention addresses this need.

### SUMMARY OF THE INVENTION

The present invention is directed toward an information service associated with an on-line commercial web site. In addition to performing the standard buying and selling of products, the web site of the present invention provides an information service, wherein records of products purchased by consumers are kept. Consumers can use their records to access post-sale information regarding their purchased products, such as bulletins and recall information, and participate in interactive information exchange with the web site, such as keeping track of product maintenance history and scheduled maintenance.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which the present invention can be implemented;

FIG. 2 is a block diagram of a server in the distributed data processing system of FIG. 1;

FIG. 3 is a block diagram of a client in the distributed data processing system of FIG. 3;

FIG. 4 is a diagram of a browser program operable on a client in accordance with a preferred embodiment of the present invention;

FIG. 5A is a screen shot of a web site developed in accordance with a preferred embodiment of the present invention;

FIG. 5B is a screen shot of an authentication screen of a web site developed in accordance with a preferred embodiment of the present invention;

FIG. 6 is a screen shot of an order status web page in a web site developed in accordance with a preferred embodiment of the present invention;

FIG. 7 is a screen shot of a catalog web page in a web site developed in accordance with a preferred embodiment of the present invention;

FIG. 8 is a screen shot of a product description page in a web site developed in accordance with a preferred embodiment of the present invention;

FIG. 9 is a screen shot of an inventory management web page in a web site developed in accordance with a preferred embodiment of the present invention;

FIG. 10 is a screen shot of a product management web page in a web site developed in accordance with a preferred embodiment of the present invention;

FIG. 11 is a screen shot of a maintenance history web page in a web site developed in accordance with a preferred embodiment of the present invention;

FIG. 12 is a screen shot of a consumables usage web page in accordance with a preferred embodiment of the present invention;

FIG. 13 is a screenshot of a web page for a merchant to enter information about a customer's product in a preferred embodiment of the present invention;

FIG. 14 is a screenshot of a web page presenting an organization's inventory to a user in a preferred embodiment of the present invention;

FIG. 15 is a screenshot of a web page for a merchant to enter information regarding a particular type of product in a preferred embodiment of the present invention; and

FIG. 16 is a flowchart representation of the purchase of a product using a web site developed in accordance with a preferred embodiment of the present invention.

### DETAILED DESCRIPTION OF THE PREFERRED EMBODIMENT

With reference now to the figures, and in particular with reference to FIG. 1, a pictorial representation of a distributed data processing system in which the present invention may be implemented is depicted.

Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, servers 104A and 104B are connected to network 102 along with storage unit 106. In addition, clients 108, 110, and 112 also are connected to a network 102. These clients 108, 110, and 112 maybe, for example, personal computers or network computers. For purposes of this application, a network computer is any computer, coupled to a network, which receives a program or other application from another computer coupled to the network. In the depicted example, servers 104A provide data to clients 108-112. Clients 108, 110, and 112 are clients with respect to servers 104A and 104B. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, distributed data processing system 100 also maybe implemented as an umber of different types of networks, such as for example, an intranet or a local area network.

Servers 104A and 104B and the other systems within distributed data processing system 100 need not be affiliated with the same party or organization. For example, server 104A may provide World Wide Web information from Company X, while server 104B stores a database for Company Y. Also, tasks may be distributed across multiple servers in distributed data processing system 100. For example, server 104A may report information from server 104B's database using the World Wide Web.

FIG. 1 is intended as an example, and not as an architectural limitation for the processes of the present invention.

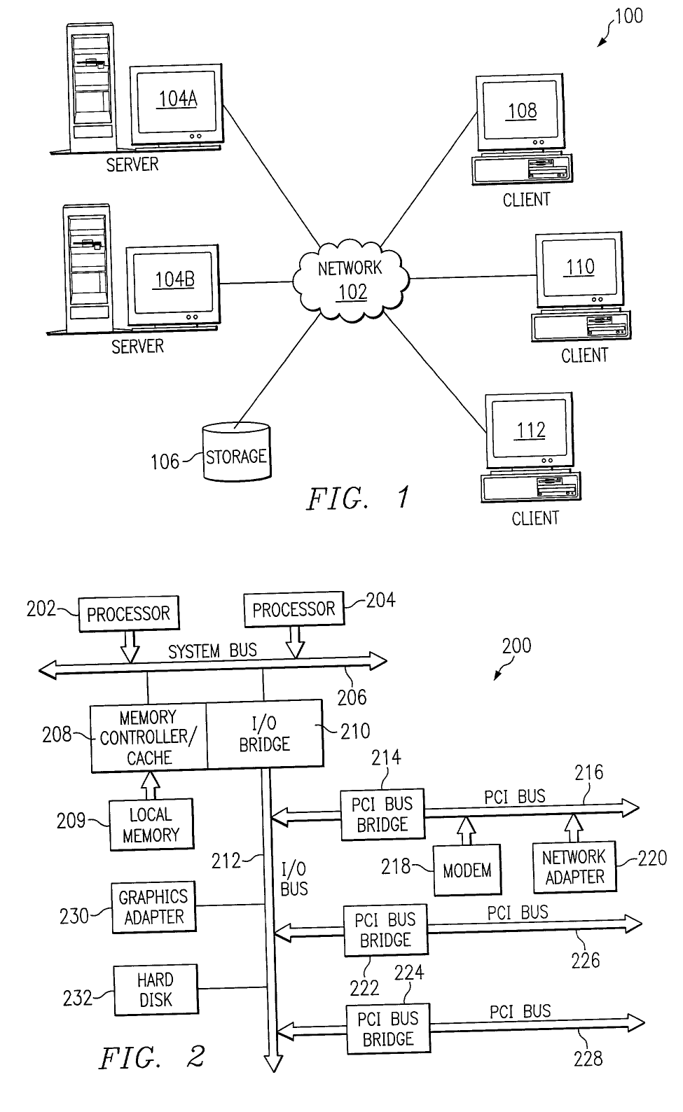

Referring to FIG. 2, a block diagram of a data processing system which may be implemented as a server, such as server 104 in FIG. 1, is depicted in accordance to the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drive and the like also may be used in addition or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

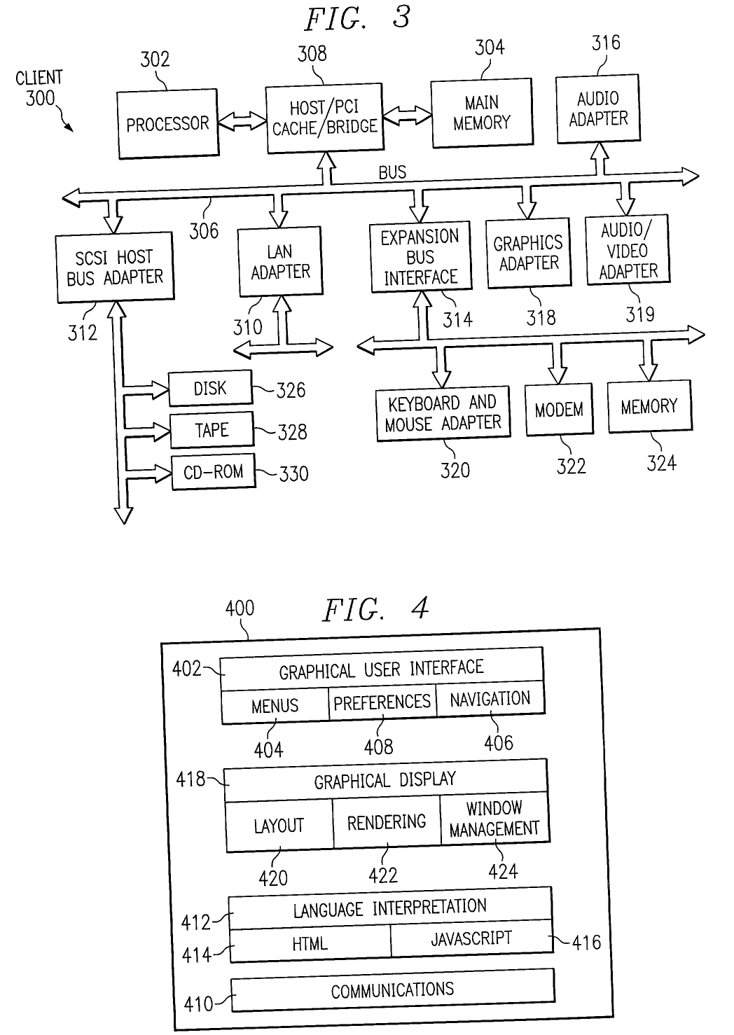

With reference now to FIG. 3, a block diagram of a data processing system in which the present invention may be implemented is illustrated. Data processing system 300 is an example of a client computer. Data processing system 300 employs a peripheral component interconnect (PC) local bus architecture. Although the depicted example employs a PCI bus, other bus architectures such as Micro Channel and ISA may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, CD-ROM drive 330, and digital video disc read only memory drive (DVD-ROM) 332 in the depicted example. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system such as Microsoft Windows 2000, which is available from Microsoft, Inc. of Redmond, Wash. “Microsoft Windows” is a trademark of Microsoft, Inc. An object oriented programming system such as Java may run in conjunction with the operating system and provides calls to the operating system from Java programs or applications executing on data processing system 300. Instructions for the operating system, the object-oriented operating system, and applications or programs are located on storage devices, such as hard disk drive 326 and may be loaded into main memory 304 for execution by processor 302.

Those of ordinary skill in the art will appreciate that the hardware in FIG. 3 may vary depending on the implementation. For example, other peripheral devices, such as optical disk drives and the like may be used in addition to or in place of the hardware depicted in FIG. 3. The depicted example is not meant to imply architectural limitations with respect to the present invention. For example, the processes of the present invention may be applied to multiprocessor data processing system.

Turning next to FIG. 4, a block diagram of a browser program is depicted in accordance with a preferred embodiment of the present invention. A browser is an application used by a client data processing system, such as client 108 in FIG. 1, to navigate or view information or data in a distributed database, such as the Internet or the World Wide Web.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select web sites for viewing. For example, navigation 406 may allow a user to see a previous page or a subsequent page relative to the present page. Preferences such as those illustrated in FIG. 4 may be set through preferences 408.

Communications 410 is the mechanism with which browser 400 receives documents and other resources from a network such as the Internet. Further, communications 410 is used to send or upload documents and resources onto a network. In the depicted example, communications 410 uses HTTP. Other protocols may be used depending on the implementation. Documents that are received by browser 400 are processed by language interpretation 412, which includes an HTML unit 414 and a JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting web pages to a user based on results from language interpretation 412.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 make be implemented using know browser applications, such Netscape Navigator or Microsoft Internet Explorer. Netscape Navigator is available from Netscape Communications Corporation while Microsoft Internet Explorer is available from Microsoft Corporation.

The present invention provides a method, apparatus, and instructions for providing a World-Wide Web-based commercial site with post-sale services to be displayed in a browser, such as browser 400. Typically, a server such as server 104 in FIG. 1 would provide web pages to be displayed in the browser, where the browser is operating on a client machine, such as client 108 in FIG. 1. A customer, operating the client, would interact with the server using the browser program. This description of a preferred embodiment, being approached from the customer's point of view, is thus centered around the interaction that takes place at the customer's browser. One of ordinary skill in the art will appreciate, however, that the information service itself is provided by the server with which the browser is in communication.

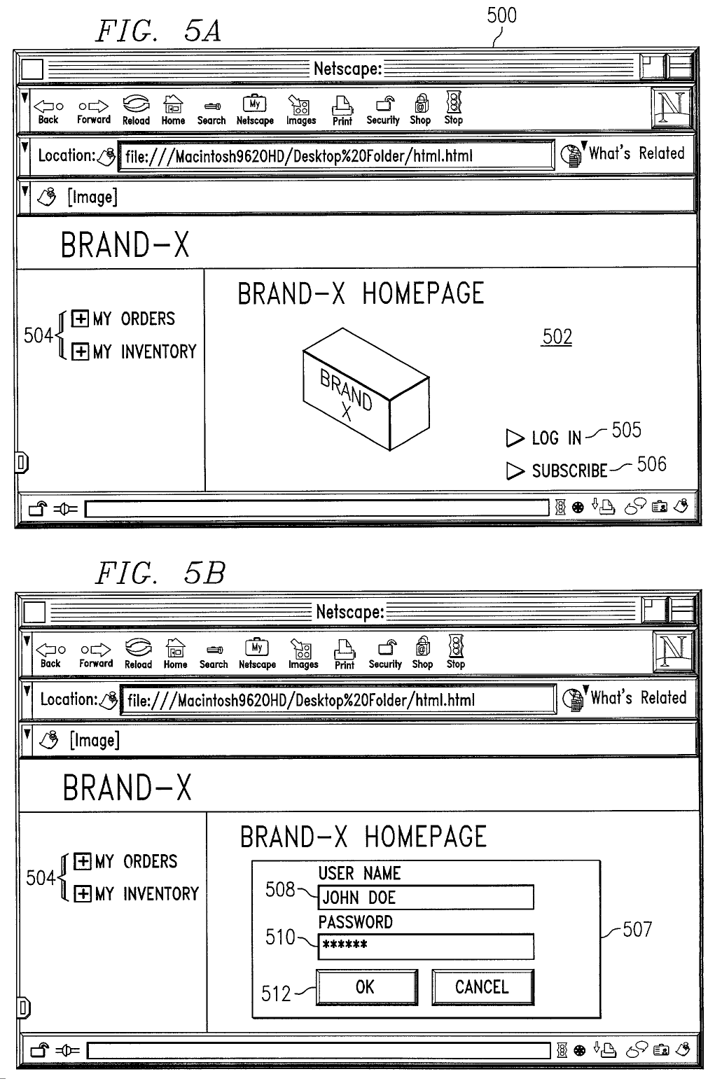

FIG. 5A is a screen shot of a web browser 500, displaying a home page 502 of a web site developed in accordance with an embodiment of the present invention. Home page 502 contains controls 504 for accessing the two primary areas within the website, “My Orders,” which allows the user to place orders for products as well as view information pertaining to pending orders, and “My Inventory,” which allows a user to access post-sale resources for products purchased from the web site. Also included are a “Log in” control 505 for authenticating the user of the web site and a “Subscribe” control 506, which, when clicked, displays a page for creating a user account for a first-time customer.

If a user clicks either controls 504 or “Log in” control 505, an authentication dialog box 507 is displayed (FIG. 5B). Authentication dialog box 507 contains a “username” text field 508 and a “password” text field 510. To log into the web site, a customer enters a username and password into username text field 508 and password text field 510, respectively, then clicks “OK” button 512.

After the customer has logged in, if the customer has already clicked one of controls 504, a page corresponding to the selected control will be displayed. If the customer used “Log in” control 505 to enter the site, the customer is given the choice of clicking on the controls 504 to access a desired service.

As an alternative to requiring the user to enter a username and password every time he or she uses the site, software associated with the site may place a “persistent cookie” on the customer's computer. A persistent cookie is a small morsel of information (generally less than 4 kilobytes in length) stored on a user's computer that may be retrieved by a web site at a later time, even after the current communication session has ended. The web site in an embodiment of the present invention, then, could place a cookie containing identification information on the customer's computer, which could then be retrieved the next time the customer accesses the web site. By employing a cookie, there is no need for the customer to enter a username and password, because the user can be readily identified and authenticated using the information stored in the persistent cookie.

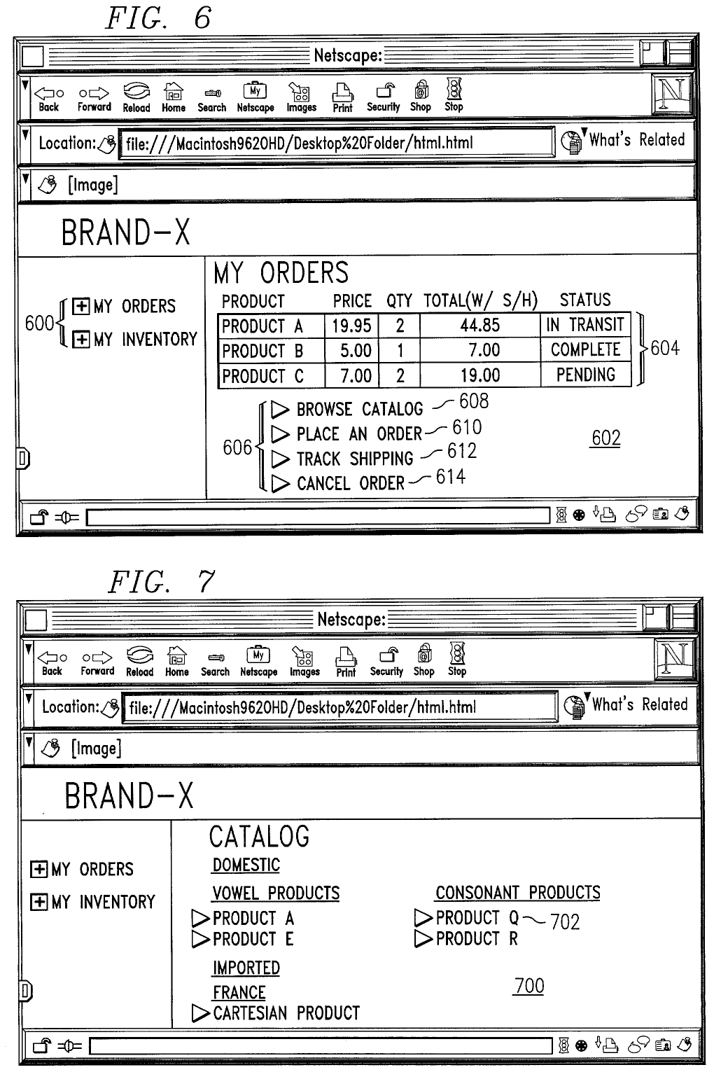

If the customer clicks control 600 (FIG. 6), a page such as web page 602, entitled “My Orders,” will be displayed. Web page 602 includes a table 604 showing orders placed by the logged-in customer and their status. Also included are a set of controls 606 for performing order-related functions.

Clicking control 608 directs the customer to a catalog of products for sale. If the customer already knows what he or she wishes to buy, the customer may click control 610 to be directed to an order-form web page to order the product(s). To track the progress of a product being shipped to the customer, the customer may click control 612 to receive shipping status. Finally, the customer may cancel a pending order by clicking control 614.

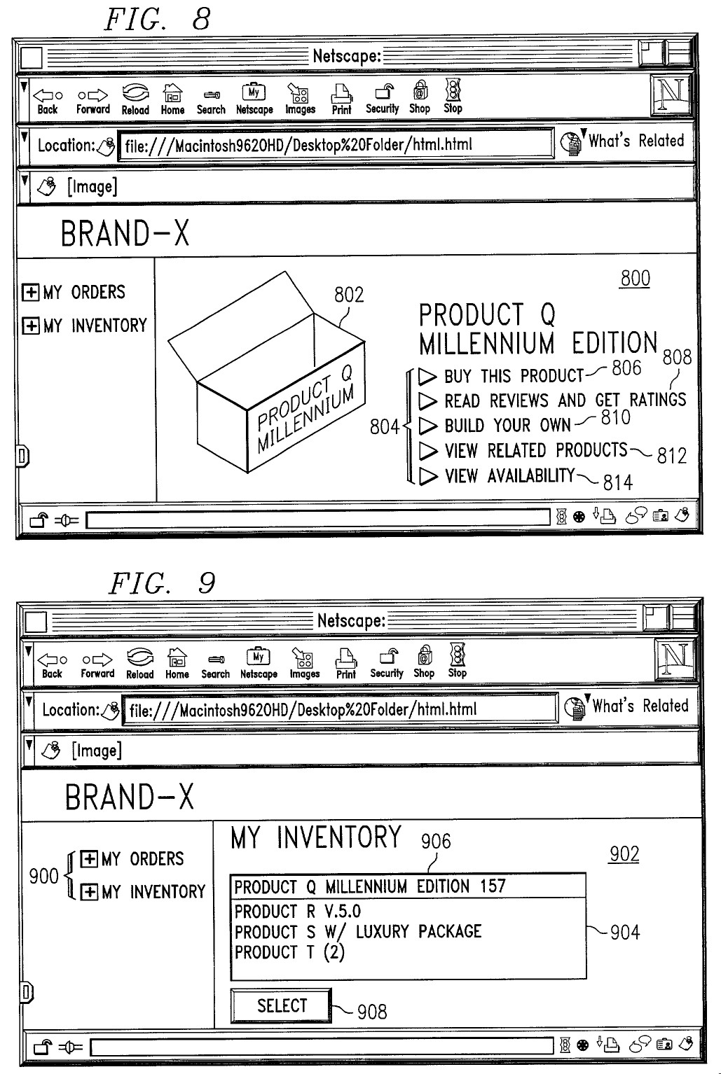

If the customer clicks control 608, web page 700 is displayed (FIG. 7). Web page 700 contains a list of products available for purchase, arranged by category. Clicking one of the products, such as product 702, causes a product information page such as web page 800 (FIG. 8) to be displayed.

Web page 800 contains a pictorial representation 802 of the product and a series of controls 804 to lead the customer to other pages within the site. Clicking control 806 takes the customer to a page where an order for the product can be placed. The customer can click control 808 to read reviews and ratings of the product, by professional reviewers or by other customers. Clicking control 810 takes the customer to a page where the user can specify a custom version of the product for purchase. Control 812 allows a user to browse related products. Finally, control 814 allows the customer to examine the availability of the particular product (i.e., whether the product is in stock, how many are in stock, how soon the product can be delivered, etc.).

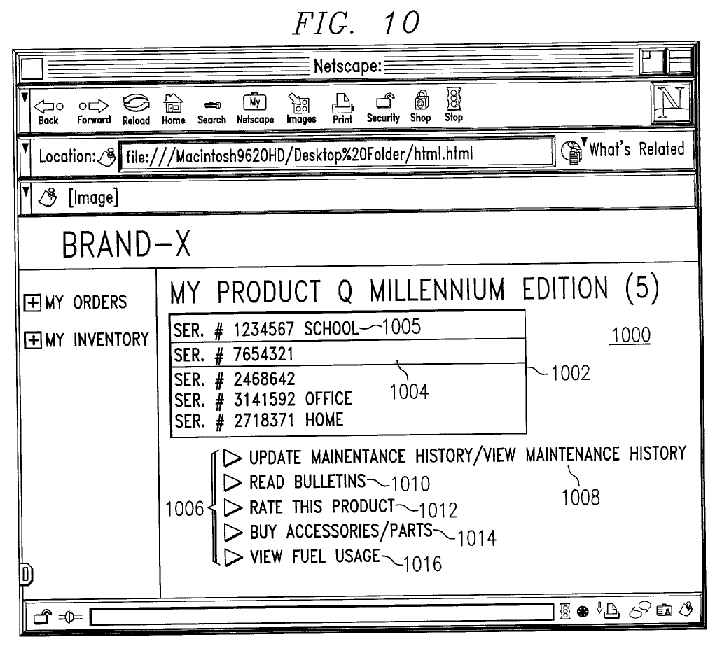

Once the customer has purchased a product through the web site, a record of the purchased product is made in a database associated with the web site. A customer may access this database by clicking control 900 (FIG. 9). When control 900 is clicked, a “My Inventory” web page 902 is displayed.

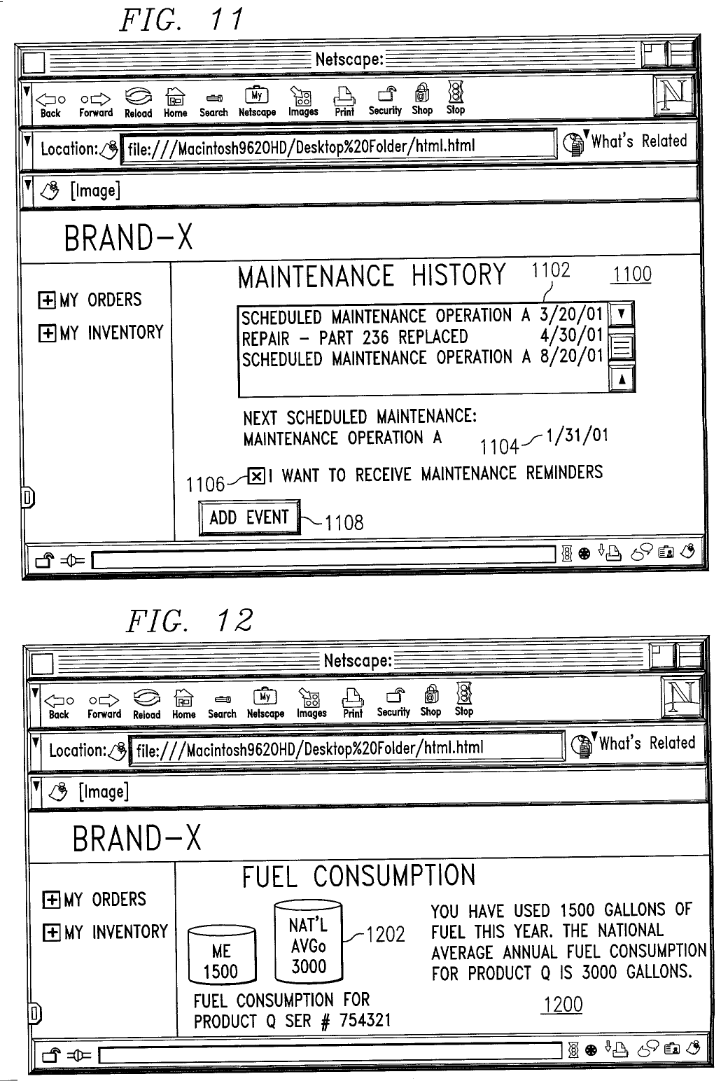

Selection box 904 in page 902 presents a list of products purchased through the site and owned by the customer, along with quantities (in parentheses). The customer may view the records associated with a particular product, such as product 906, by highlighting the product with the mouse and clicking button 908, which makes a web page such as web page 1000 (FIG. 10) appear.

Web page 1000 contains a list 1002 of the particular items of a particular product owned by the customer, some of which contain an indication of the location of the product, such as location indication 1005. Location information may help a customer distinguish between various items in the customer's inventory. In FIG. 10, these items are listed by serial number. The customer may select a particular item, such as item 1004 by highlighting the item with the mouse.

Web page 1000 also contains a number of controls 1006 for performing specific services with respect to a selected item such as item 1004 or with respect to the entire product class as a whole. Control 1008, when clicked, allows the customer to update or view the maintenance history for the selected item. Clicking control 1010 allows the customer to read product bulletins from the manufacturer or seller. Clicking control 1012 allows the customer to rate the product. Clicking control 1014 takes the customer to a web page for purchasing accessories or parts for the product. Finally, clicking control 1016 allows fuel usage for the product to be displayed.

One of ordinary skill in the art will appreciate that a number of different services or options may be provided in similar web pages within the present invention. These services or options may include options for viewing manufacturer or seller information about the product, such as recommended problem fixes, usage tips, geographically based statistics (such as national or local averages), or white papers, or they may include options for submitting or viewing information provided by the customer, such as the customer's experiences with the product, the customer's consumables usage (for instance, how much toner was used in a laser printer), performance errors or problems, usage tips or guidelines from the customer.

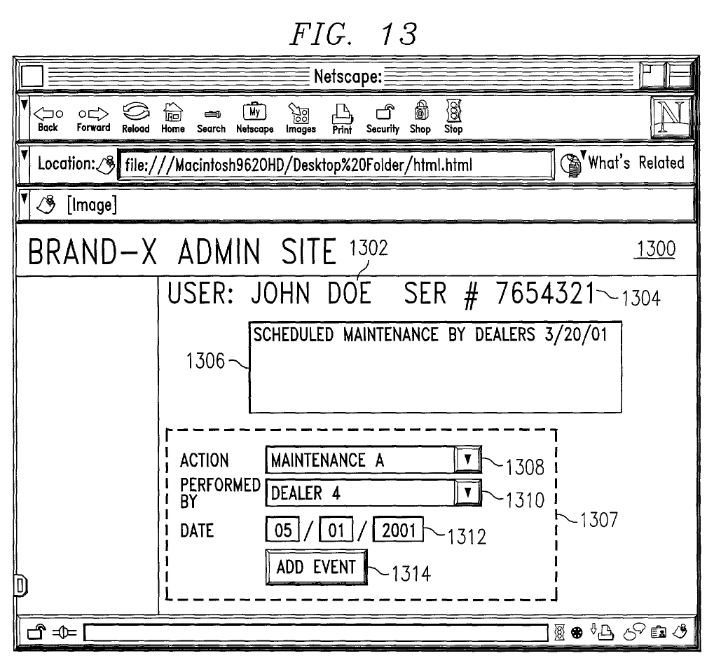

As an example of a possible service that may be employed by a customer, FIG. 11 is a screen shot of a web page 1100 displayed when control 1008 is clicked. Web page 1100 contains a scrollable log 1102 of maintenance events in the service life of a particular product owned by the customer. Also contained in web page 1100 is a display 1104 of the next scheduled item of maintenance to be performed. If the customer desires, the customer may opt to be sent reminders, via electronic mail (e-mail), of scheduled maintenance operations to be performed; the user can select whether to receive the reminders by marking checkbox 1106. Finally, the customer may add a new event to the maintenance history (e.g., a recently-completed maintenance task) by clicking button 1108.

FIG. 12 is a depiction of a web page 1200 providing a description of a customer's consumable usage with respect to a product owned by the consumer, in accordance with a preferred embodiment of the present invention. In web page 1200, graph 1202 compares the customer's fuel usage with a national average compiled from a national aggregation of customers' data. The customer's usage of a consumable (such as fuel, in this case) can be determined in a number of ways. The consumables vendor may report purchases of consumables by sending a network message to a server associated with web page 1200. An alternative method of reporting consumables usage would be for the product itself to be connected to a network (perhaps through a wireless link) and for the product to report its own consumables usage as the consumables are used.

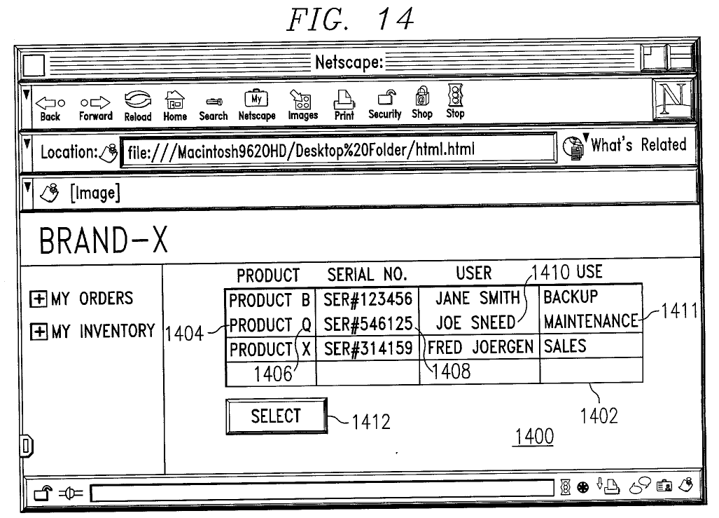

FIG. 13 is an example of a web page 1300 with which a manufacturer or vendor can provide information about items in a customer's inventory. Web page 1300, in the depicted example, is directed toward providing a facility for a vendor to enter information about maintenance procedures performed on a customer's product. User ID 1302 identifies the customer in question, and serial number 1304 identifies an item within the customer's inventory. Maintenance log 1306 displays a list of maintenance operations performed on the item. Submitting information through form 1307 results in an entry being created in maintenance log 1306.

Form 1307 contains a number of controls for entering and submitting maintenance data for inclusion in the maintenance log. Pulldown menu 1308 allows the selection of a maintenance action performed. Pulldown menu 1310 allows the person who performed the maintenance action to be selected. Date field 1312 allows the date on which the maintenance was performed to be entered. Finally, button 1314 allows the submission of the information in form 1307 as an entry into maintenance log 1306.

FIG. 14 is a depiction of a web page 1400 in which the product inventory of a organizational customer is depicted. List box 1402 allows a member of the organizational customer to select an item from among a list containing items controlled by various members of the organization, so as to allow the display of information pertaining to that item. For instance, entry 1404 represents an item having a product type 1406, a serial number 1408, a controlling organization member (or “user” of the item) 1410, and for what purpose the item is used within the organization 1411. Selecting an entry from list box 1402 and clicking “select” button 1412 displays a page similar to that in FIG. 10 for the item.

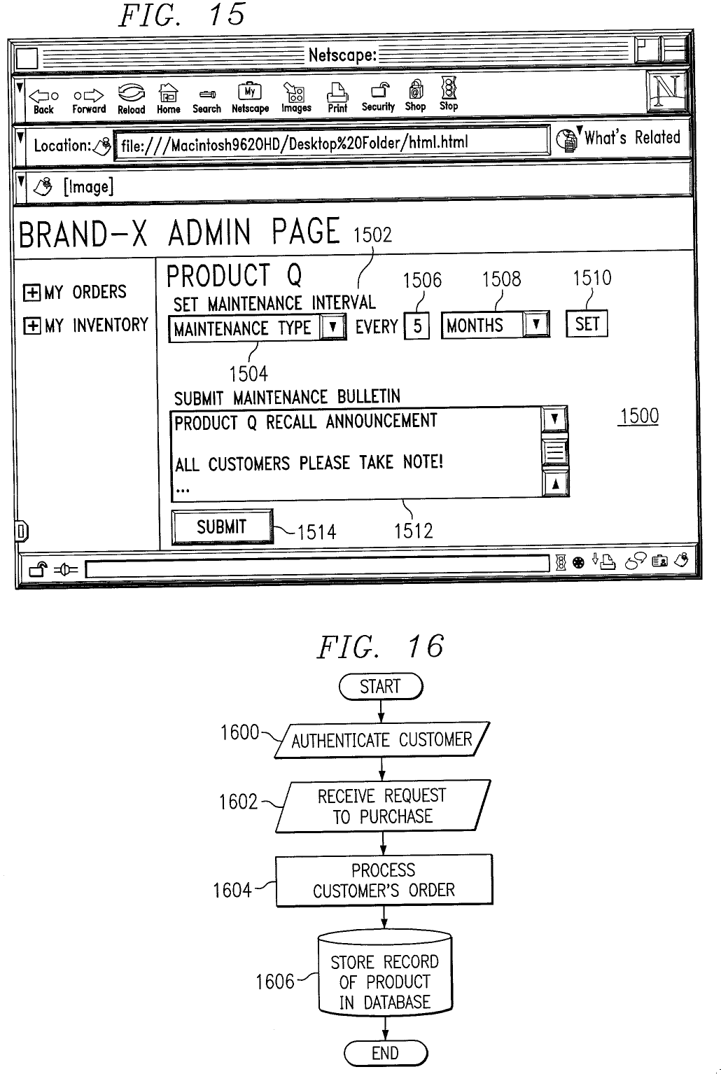

FIG. 15 depicts a web page 1500 for allowing a vendor or manufacturer to enter information about a particular type of product for dissemination to customers owning that product, in accordance with a preferred embodiment of the present invention. Subform 1502 allows a maintenance interval for the product to be entered. A type of maintenance to be performed (e.g., an oil change) is selected from pulldown menu 1504. A numeric interval is entered in field 1506 and a unit of time measurement is selected from pulldown menu 1508. Clicking button 1510 sets the new maintenance interval. Edit box 1512 provides an editing area for entering announcements (in this case, maintenance bulletins) pertaining to the product. Clicking 1514 publishes the announcement to customers of that product (i.e., makes it available to them).

FIG. 16 is a flowchart representation of a process of selling a product in a preferred embodiment of the present invention. First, the customer is authenticated (step 1600). Next, a request to purchase a product or products is received (step 1602). Then, the customer's order is processed (e.g., payment collection and shipping begin) (step 1604). Finally, a record of the product purchase is stored in an inventory of the customer's purchases (step 1606).

A number of variations from the preferred embodiment described here are possible. For instance, in one variation of the invention, information is not only collected from the buyer and seller, but also from devices in a communication network, such as the product itself (e.g., a car transmits diagnostic information) or from devices related to the product (e.g., the pump at a service station transmits the amount of gasoline purchased. In yet another variation of the invention, a further process of analysis or “data mining” is performed on the collected data to derive an inference, and the inference is made available to the buyer or seller (or both). A simple example of this would be to take mileage and fuel consumption information for an automobile and calculate the fuel economy; a more complicated example would be to “data mine” through maintenance records to help determine what may be wrong or broken with the vehicle.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing information to sales customers, comprising the steps of:
establishing a data record associated with a product;
receiving first data from a seller;
storing the first data in the data record;
receiving second data from a buyer;
storing the second data in the data record; and
responsive to a display request from the buyer, displaying selected data from the data record.

2. The method of claim 1, wherein the step of establishing is executed in response to the buyer's buying the product.

3. The method of claim 1, wherein the selected data includes the first data.

4. The method of claim 1, wherein the selected data includes the second data.

5. The method of claim 1, wherein the first data includes at least one of a recommended maintenance schedule, a recommended problem fix, product usage information, maintenance history, errors in performance, a statistic, and a white paper.

6. The method of claim 1, wherein the second data includes at least one of maintenance history, user experience, user guidelines, information on similar products, consumables usage, errors in performance, an identity of a user, a use for the product, a location of the product and information on related products.

7. The method of claim 1, further comprising the step of:
receiving third data from the seller;
receiving fourth data from the buyer;
synthesizing fifth data from the third data and the fourth data; and
storing the fifth data in the data record.

8. The method of claim 7, wherein the selected data includes the fifth data.

9. The method of claim 7, wherein the fifth data includes at least one of an order status, an order price, an order quantity, and an order date.

10. The method of claim 7, wherein the fifth data includes a comparison with a statistic.

11. The method of claim 1, wherein the step of displaying includes displaying the selected data in a web browser.

12. The method of claim 1, further comprising the step of:
responsive to a buy request from the buyer, ordering a related product, wherein the related product is related to the product.

13. The method of claim 1, further comprising the step of:
displaying a quote of availability of the product to the buyer.

14. The method of claim 1, further comprising the step of:
authenticating the buyer.

15. The method of claim 1, further comprising the step of:
analyzing at least one of the first data and the second data to produce an inference.

16. The method of claim 15, further comprising the step of:
reporting the inference to the buyer.

17. The method of claim 15, further comprising the step of:
reporting the inference to the seller.

18. The method of claim 1, further comprising the steps of:
receiving third data from a device in a communications network; and
storing the third data in the data record.

19. The method of claim 18, wherein the device is the product.

20. The method of claim 18, wherein the device is related to the product.

21. A computer program product, in a computer-readable medium, for providing information to sales customers, comprising instructions for:
establishing a data record associated with a product;
receiving first data from a seller;
storing the first data in the data record;
receiving second data from a buyer;
storing the second data in the data record; and
responsive to a display request from the buyer, displaying selected data from the data record.

22. The computer program product of claim 21, wherein the instructions for establishing are executed in response to the buyer's buying a product.

23. The computer program product of claim 21, wherein the selected data includes the first data.

24. The computer program product of claim 21, wherein the selected data includes the second data.

25. The computer program product of claim 21, wherein the first data includes at least one of a recommended maintenance schedule, a recommended problem fix, product usage information, maintenance history, errors in performance, a statistic, and a white paper.

26. The computer program product of claim 21, wherein the second data includes at least one of maintenance history, user experience, user guidelines, information on similar products, consumables usage, errors in performance, a user identity, a use for the product, a location of the product, and information on related products.

27. The computer program product of claim 21, further comprising instructions for:
receiving third data from the seller;
receiving fourth data from the buyer;
synthesizing fifth data from the third data and the fourth data; and
storing the fifth data in the data record.

28. The computer program product of claim 27, wherein the selected data includes the fifth data.

29. The computer program product of claim 27, wherein the fifth data includes at least one of an order status, an order price, an order quantity, and an order date.

30. The computer program product of claim 27, wherein the fifth data includes a comparison with a statistic.

31. The computer program product of claim 21, wherein the instructions for displaying include instructions for displaying the selected data in a web browser.

32. The computer program product of claim 21, further comprising instructions for:
responsive to a buy request from the buyer, ordering a related product, wherein the related product is related to the product.

33. The computer program product of claim 21, further comprising instructions for:
displaying a quote of availability of the product to the buyer.

34. The computer program product of claim 21, further comprising instructions for:
authenticating the buyer.

35. The computer program product of claim 21, further comprising instructions for:
analyzing at least one of the first data and the second data to produce an inference.

36. The computer program product of claim 35, further comprising instructions for:
reporting the inference to the buyer.

37. The computer program product of claim 35, further comprising instructions for:
reporting the inference to the seller.

38. The computer program product of claim 21, further comprising instructions for:
receiving third data from a device in a communications network; and
storing the third data in the data record.

39. The computer program product of claim 38, wherein the device is the product.

40. The computer program product of claim 38, wherein the device is related to the product.

41. An apparatus for providing information to sales customers, comprising means for:
establishing a data record associated with a product;
receiving first data from a seller;
storing the first data in the data record;
receiving second data from a buyer;
storing the second data in the data record; and
responsive to a display request from the buyer, displaying selected data from the data record.

42. The apparatus of claim 41, wherein the means for establishing operates in response to the buyer's buying the product.

43. The apparatus of claim 41, wherein the selected data includes the first data.

44. The apparatus of claim 41, wherein the selected data includes the second data.

45. The apparatus of claim 41, wherein the first data includes at least one of a recommended maintenance schedule, a recommended problem fix, product usage information, maintenance history, errors in performance, a statistic, and a white paper.

46. The apparatus of claim 41, wherein the second data includes at least one of maintenance history, user experience, user guidelines, information on similar products, errors in performance, consumables usage, a user identity, a use for the product, a location of the product, and information on related products.

47. The apparatus of claim 41, further comprising means for:
receiving third data from the seller;
receiving fourth data from the buyer;
synthesizing fifth data from the third data and the fourth data; and
storing the fifth data in the data record.

48. The apparatus of claim 47, wherein the selected data includes the fifth data.

49. The apparatus of claim 47, wherein the fifth data includes at least one of an order status, an order price, an order quantity, and an order date.

50. The apparatus of claim 47, wherein the fifth data includes a comparison with a geographically based statistic.

51. The apparatus of claim 41, wherein the means for displaying includes means for displaying the selected data in a web browser.

52. The apparatus of claim 41, further comprising means for:
responsive to a buy request from the buyer, ordering a related product, wherein the related product is related to the product.

53. The apparatus of claim 41, further comprising means for:
displaying a quote of availability of the product to the buyer.

54. The apparatus of claim 41, further comprising means for:
authenticating the buyer.

55. The apparatus of claim 41, further comprising means for:
analyzing at least one of the first data and the second data to produce an inference.

56. The apparatus of claim 55, further comprising means for:
reporting the inference to the buyer.

57. The apparatus of claim 55, further comprising means for:
reporting the inference to the seller.

58. The apparatus of claim 41, further comprising means for:
receiving third data from a device in a communications network; and
storing the third data in the data record.

59. The apparatus of claim 58, wherein the device is the product.

60. The apparatus of claim 58, wherein the device is related to the product.

61. A data processing system to provide information to sales customers, comprising:
a bus system;
a processing unit, attached to the bus system and including at least one processor;
a memory, attached to the bus system; and
a set of instructions,
wherein the processing unit executes the set of instructions to perform the acts of:
establishing a data record associated with a product;
receiving first data from a seller;
storing the first data in the data record;
receiving second data from a buyer;
storing the second data in the data record; and
responsive to a display request from the buyer, displaying selected data from the data record.

62. The data processing system of claim 61, wherein the act of establishing is performed in response to the buyer's buying the product.

63. The data processing system of claim 61, further comprising:
a communications unit attached to the bus system,
wherein the data processing system receives input from the buyer and displays output to the buyer through the communications unit.

64. The data processing system of claim 61, wherein the act of displaying the selected data includes displaying the selected data in a web browser.
